(19) United States
(12) Patent Application Publication
(10) Pub. No.: US 2012/0158538 A1
(43) Pub. Date: Jun. 21, 2012

(54) TERMINAL SYSTEM, SHOPPING SYSTEM AND METHOD FOR SHOPPING USING THE SAME

(75) Inventor: Hyun Suk ROH, Daejeon (KR)

(73) Assignee: Electronics and Telecommunications Research Institute, Daejeon (KR)

(21) Appl. No.: 13/325,713

(22) Filed: Dec. 14, 2011

(30) Foreign Application Priority Data
Dec. 20, 2010 (KR) 10-2010-0130749

(51) Int. Cl. G06Q 30/00

(52) U.S. Cl. 705/26.7; 705/27.1

(57) ABSTRACT

Disclosed is a terminal system including: a first terminal, which is installed on a first indoor transport unit of shopping products, to be connected to a server through a first wireless LAN device installed on a first display stand and generates first product information of products arranged on the first display stand in connection with the server; and a second terminal, which is installed on a second indoor transport unit of the shopping products, to be connected to the server though a second wireless LAN device installed on a second display stand and generates a second product information of products arranged on the second display stand in connection with the server, wherein the first and the second terminals inter-exchange the first product information and the second product information through the first wireless LAN device, the second wireless LAN device and the server.

### CROSS-REFERENCE TO RELATED APPLICATION

This application claims priority under 35 U.S.C. §119 to Korean Patent Application No. 10-2010-0130749, filed on Dec. 20, 2010, in the Korean Intellectual Property Office, the disclosure of which is incorporated herein by reference in its entirety.

### TECHNICAL FIELD

The present invention relates to a terminal system, a shopping system and a method for shopping using the same, and more particularly, to a shopping system using a mobile network system and an augmented reality technology and a method for shopping using the same.

### BACKGROUND

It is a common sight that people acquainted with each other, such as friends and families, often visit a shopping mall together. People, who are acquainted with each other, tend to visit the shopping mall to shop and visit with each other, but they can also enjoy shopping at separate places in the shopping mall in order to buy products for each other. In this case, when person “A” wants to know what person “B”, who is accompanied with person “A”, is shopping for and buying what products, even if both persons are shopping at different places in the shopping mall, person “A” does not know what person “B” is buying. Further, when the shopping area is spacious and many visitors are shopping, such as in department stores, large supermarkets, or the like, a location of the other party cannot easily be located.

In order to exchange information with each other, a person can figure out to some extent what products the other party wants to buy and the location of the other party by using a mobile communication terminal, but exchanging shopping information with each other may be extremely limited due to incompatibility of mobile communication terminals. Of course, when using the mobile communication terminal such as a smart phone, various shopping information can be sent and received, but not everyone shopping may have the mobile communication terminal such as the smart phone. Moreover, it is not realistic to expect that every person would purchase an expensive smart phone for shopping.

### SUMMARY

An exemplary embodiment of the present invention provides a terminal system including: a first terminal, which is installed on a first indoor transport unit of shopping products, to be connected to a server through a first wireless LAN device installed on a first display stand and generates first product information of products arranged on the first display stand in connection with the server; and a second terminal, which is installed on a second indoor transport unit of the shopping products, to be connected to the server through a second wireless LAN device installed on a second display stand and generates second product information of products arranged on the second display stand in connection with the server.

The first and the second terminals inter-exchange the first product information and the second product information through the first wireless LAN device, the second wireless LAN device and the server.

Another exemplary embodiment of the present invention provides a shopping system including: first and second wireless LAN devices each installed on a first and a second display stand in the shopping mall; a first terminal installed on a first indoor transport unit transporting products to communicate with the first wireless LAN device in wireless and having a image capturing unit; a server receiving product image information captured from products arranged in the first display stand by using the image capturing unit of the first terminal through an internet network in connection with the first wireless LAN device and the second wireless LAN device; and a second terminal installed on a second indoor transport unit transporting products to be communicated with the second wireless LAN device in wireless and having an image display unit to display the product image information captured from products arranged on the first display stand received from the server through the internet network and the second wireless LAN device on the image display unit.

Other features and aspects will be apparent from the following detailed description, the drawings, and the claims.

### BRIEF DESCRIPTION OF THE DRAWINGS

FIG. 1 is a block diagram illustrating a shopping system according to an exemplary embodiment of the present invention.

FIG. 2 is a block diagram illustrating respective inner configurations of terminals shown in FIG. 1.

FIG. 3 is a flow chart illustrating a process when a user receives shopping services by using the shopping system shown in FIG. 1.

FIG. 4 is a flow chart illustrating a process when product image information among the shopping services shown in FIG. 3 is transmitted to a shopping cart of the other party.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the present invention, a way capable of inter-exchanging a variety of information is proposed by using terminals that are installed on an indoor transport unit such as a shopping cart located in a shopping mall.

In the present invention, terminals each installed on indoor transport units exchange location information between indoor transport units and of products through wireless LAN devices each installed on the display stand arranging the products and accordingly, shopping services inter-exchanging product information, which includes product list information, text information and product image information between the indoor transport units, or the like, is provided.

In the present invention, a group communication way in which indoor transport units configured by a first session can communicate with each other is proposed and when there are a lot of users, the efficiency of a network can be improved by using minimal network resources.

Hereinafter, exemplary embodiments of the present invention will be described with reference to accompanying drawings in detail.

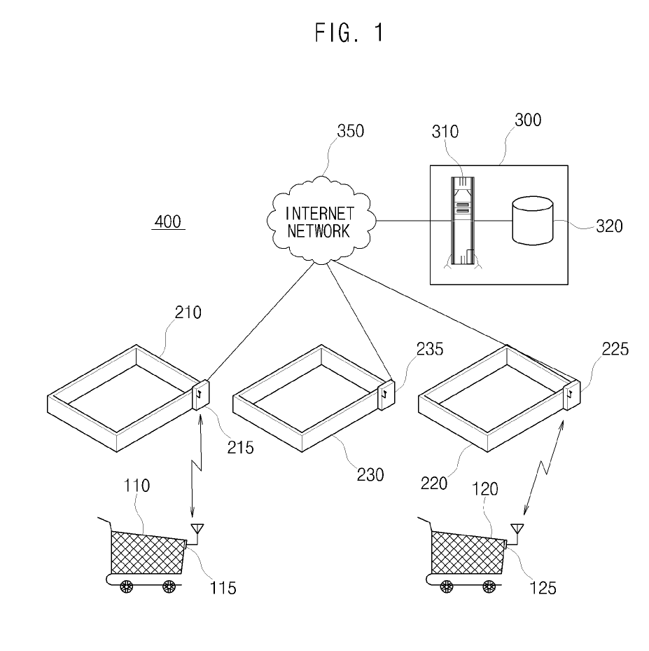

FIG. 1 is a block diagram illustrating a shopping system according to an exemplary embodiment of the present invention.

Referring to FIG. 1, the shopping system according to the exemplary embodiment includes a terminal system and a server (shopping mall server) which communicates through the terminal system and an internet network 350.

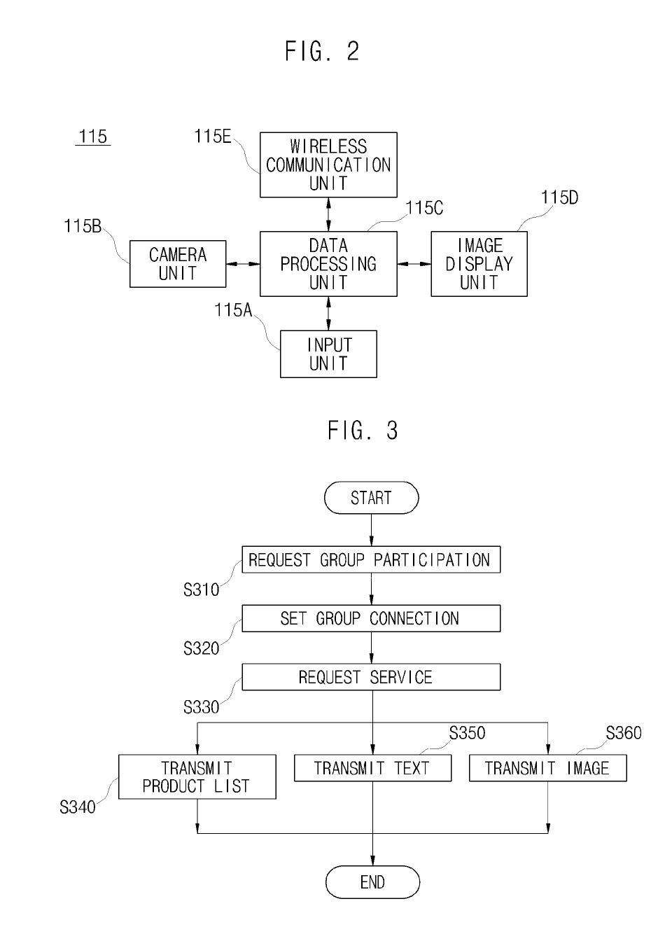

In the exemplary embodiment, each of a plurality of terminals is described with reference to FIG. 2, but the terminals implemented as configurations shown in FIG. 2 are not limited and any type of computer systems which can communicate by wireless is sufficient. For example, the computer system may be personal computers, workstations, laptops and the like.

Hereinafter, as described below, communication between the terminal system and a server system can be performed by any type of public network such as the Internet or any private network such as a local area network (LAN), a wide area network (WAN), a virtual private network (VPN) and the like. Further, as described below, communication performed within a terminal system, that is, communication between a terminal installed on an indoor transport unit and a wireless LAN device installed on a display stand on which products are arranged and displayed can be performed by any private network such as a local area network (LAN), a wide area network (WAN), a virtual private network (VPN) and the like.

The terminal system includes a plurality of indoor transport units such as shopping carts, a plurality of terminals each installed on the plurality of indoor transport units and wireless LAN devices installed on display stands arranging products. In the exemplary embodiment, for help in understanding the descriptions, a terminal system configured to include two terminals and two wireless LAN devices each communicating with the two terminals in wireless is described. Hereinafter, the two terminals refers to a first terminal 115 and a second terminal 125, respectively, and an indoor transport unit on which the first terminal is installed refers to a first indoor transport unit and, an indoor transport unit on which the second terminal is installed, a second indoor transport unit. Further, two wireless LAN devices refer to a first wireless LAN device 215 and a second wireless LAN device 225, respectively. In addition, hereinafter, a display stand on which the first wireless LAN device 210 is installed refers to a first display stand, and a display stand on which the second wireless LAN device 225 is installed, a second display stand 220.

The first terminal 115 configuring the terminal system is installed on the first indoor transport unit 110 to be connected to the server system 300 through the first wireless LAN device 215 installed on the first display stand 210.

The first terminal 115 is connected to the server system 300 and generates product information (hereinafter, refers to first product information) of products arranged on the first display stand 210 in connection with the server system 300. Herein, the first product information includes first product list information generated by the first terminal 115 through a product search service application provided from the server system 300. The first product list information may be list information of the products arranged on the first display stand 210 and list information of products of the first terminal 115 selected by a user of the first terminal 115 among list information of products provided in the product search service application through the first terminal 115. Further, the first product list information includes first product image information of which the products arranged on the first display stand 210 are captured. In addition, the first product list information may include various text information directly inputted by the user through the first terminal 210.

The first product information including the first product list information, the text information and the first product image information is transmitted to the server system 300 through the first wireless LAN device 215 and the Internet network 350 and the server system 300 transmits the transmitted first product information to the second indoor transport unit 120 through the internet network 350, the second wireless LAN device 225 and the second terminal 125.

Similarly, the second terminal 125 installed on the second indoor transport unit 120 transmits the second product information, that is, the second product list information of products arranged on the second display stand 220, the text information of when a user of the second indoor transport unit 120 wants to transfer to a user of the first indoor transport unit 110 and the second product image information captured from products arranged on the second display stand 220 to the first terminal 115 through the Internet network 350 and the first wireless LAN device 215.

Meanwhile, the server system 300 includes a server 310 and a storage unit 310.

The server 310 determines whether the current indoor transport units are connected to any wireless LAN devices and determines locations of respective indoor transport units based on the results. Then, each of the respective indoor transport units is connected to the corresponding wireless LAN device to provide services search of product information, exchange of location information of the other indoor transport unit interested by the user, exchange of the product image information and the like to the user.

Specifically, the server 310 provides various types of information relevant to the search services of the products arranged on the shopping mall to the terminal system through the Internet network 350 and mediates group communication between the first indoor transport unit 110 and the second indoor transport unit 120. To this end, the server 310 configures a session between the first indoor transport unit 110 and the second indoor transport unit 120. In a state where the session is configured (or established), when the first and second indoor transport units 110 and 120 requests a group communication participation to the server, the respective indoor transport unit is authenticated according to the request and the group communication is mediated after completing the authentication. In the group communication process, the first and second indoor transport units inter-exchange the respective product information, that is, the product list information, the text information, the product image information, and the like. Although units for performing the functions are not shown in the server 310, the server 310 may include a center operation unit (CPU), a memory, a bus, an input/output (I/O) interface and the like. The CPU controls the overall operation of the respective configurations of the server and the memory may include any known type of data storage and/or transmission media including a magnetic media, an optical media, a random access memory (RAM), a read-only memory (ROM), a data cache 40, a data object and the like.

The storage unit 310 may be a system (for example, database) capable of providing an information storage in the exemplary embodiment. The information may include various application program information related to shopping such as search service application software to be provided to the terminal system by the server 310, detail information on the products in the shopping mall for providing the search service, identification information set for each indoor transport unit, and identification information of the wireless LAN devices installed on the respective display stands. Above all, the identification information of the wireless LAN devices may be used to calculate a movement distance between the indoor transport units performing a group communication. For example, it may safely be said that when the first indoor transport unit 110 enters a scope which may communicate with the first wireless LAN device 215 in wireless, a location of the first indoor transport unit 110 refers to a location (first display stand) on which the first wireless LAN device 215 is installed. Likewise, it may safely be said that when the second indoor transport unit 120 enters a scope which may be communicated with the second wireless LAN device 225 wirelessly, a location of the second indoor transport unit 120 refers to a location (second display stand) on which the second wireless LAN device 225 is installed. Since the location information (or location coordinate) of the first wireless LAN device 115 and the location information of the second wireless LAN device 225 is already stored in the server 310, when using those location coordinates, a movement distance between the first indoor transport unit 110 and the second indoor transport unit 120 is calculated by using various calculation ways. The calculated movement distance may be transmitted to the terminals of the respective indoor transport units and accordingly, a user of the corresponding terminal may determine the location of the other party and can easily locate the other party.

FIG. 2 is a block diagram illustrating respective inner configurations of terminals shown in FIG. 1.

Referring to FIG. 2, the first and second terminals 115 and 125 generate first and second product information, respectively. Further, in order to transmit the generated first and second product information to an indoor transport unit on which the terminal of the other party is installed, the first and second terminals 115 and 125 may include configuration blocks described below.

The first terminal 115 includes an input unit 115A, a camera unit 115B, a data processing unit 115C, an image display unit 115D, and a wireless communication unit 115E.

The input unit 115A is an interface such as a key input unit which receives input information according to the user's operation of the first terminal 115. The user can instruct processing operations performed in the first terminal and input various information related to the products through the key input unit. The input unit 115A may include a system for exchanging information with external devices such as the image display unit. The external devices may be a speaker, a CRT, a monitor/display, an image display unit 115D such as a LCD screen, a hand-held device, a keyboard, a mouse, a voice recognition system, a voice output system and the like.

The camera unit 115B includes a camera capturing products arranged on the first display stand 210 and generates the captured image information as first product image information.

The data processing unit 115C can serve as a configuration processing data transmitted from the respective configurations, for example, a configuration which is encoded according to the prescribed way in order to increase the transmission efficiency of information having higher data amount such as the first product image information.

The image display unit 115D can serve as a configuration displaying the second product information received from the second terminal through the first wireless LAN device, the second wireless LAN device, and the server. For example, the image display unit 115D is implemented as an LCD panel to display the second product image information included in the second product information and the text information, or the like on the LCD panel.

The wireless communication unit 115E transmits the encoded first product image information to the first wireless LAN device 215 according to a wireless communication way. The encoded first product image information transmitted to the wireless communication unit 115E is transmitted to the server system 300 through the internet network 350. The server system 300 eventually transmits the transmitted first product information to the second indoor transport unit 120 on which the second terminal 125 is installed, through the second wireless LAN device 225.

The internal configuration of the second terminal 125 has the configuration identical with that of the first terminal 115. Therefore, a detailed explanation on the second terminal 125 will replace the explanation on the internal configuration of the first terminal 115.

FIG. 3 is a flow chart illustrating a process that a user receives shopping services by using the shopping system shown in FIG. 1.

Referring to FIG. 3, in the description, a process of receiving the shopping services will be described by assuming that two users acquainted with each other are visiting any shopping mall.

First, the two users each select two indoor transport units (hereinafter, refers to shopping carts) having different unique identification information provided by a shopping mall. In this case, each of the two users confirms identification information of a shopping cart selected by the other party, for example, an identification number may be in the form of numbers. Next, the two users drive terminals by operating the input unit included in terminals installed on the each selected shopping cart. Then, when the two users are shopping at different places in the shopping mall, if a first user of the two users inputs the identification number of the shopping cart of a second user, which is confirmed by the first user before shopping, through an input unit of the first terminal installed in the own shopping cart, the first terminal transmits a group participation request message to the server through the first wireless LAN device and the internet network installed on the closest first display stand of the arranged display stands (S310).

Next, in response to the group participation request message, the server transmits a group participation query message to ask whether to perform the group participation is performed to the second wireless LAN device installed on the closest second display stand of the display stands located near the closest vicinity from the shopping cart of the second user. Then, the second wireless LAN device transmits the group participation query message to the second terminal installed on the shopping cart of the second user. When the second user confirms the group participation query message and wants the group participation, the group participation response message is transmitted to the server through the second wireless LAN device and the Internet network. Then, when the server receives the group participation response message, a session for group communication between the terminal installed on the shopping cart of the first user and the terminal installed on the shopping cart of the second user is set (S320).

When the session for the group communication is set, the first user selects shopping service items provided from the first terminal installed on the own shopping cart (S330).

Next, the first user selects shopping service items, for example, any one of the shopping service items of services transmitting product list information in which the first user wants to recommend to the second user, or service (S350) transmitting text information, or service (S360) transmitting product image information using the camera to transmit the same to a shopping cart of the other party.

Similarly, the second terminal can transmit the product list information, the text information and the product image information to the first terminal.

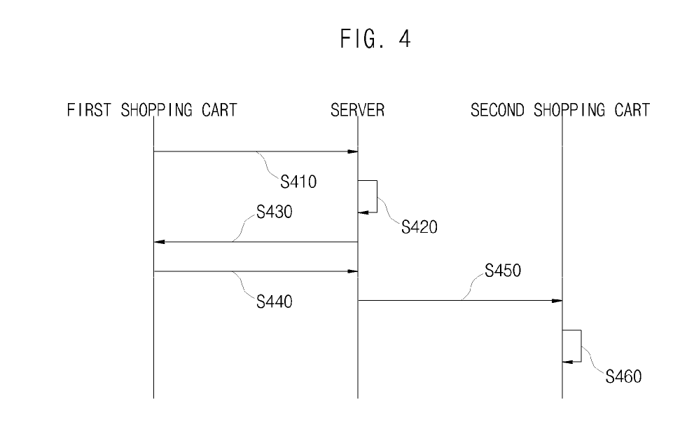

FIG. 4 is a flow chart illustrating a process when product image information among the shopping services shown in FIG. 3 is transmitted to a shopping cart of the other party.

Referring to FIG. 4, first, in order for the first user to transmit the first product image information obtained through the first terminal installed on the own shopping cart (hereinafter, refers to a first shopping cart) to the second terminal installed on the shopping cart of the second user by the first user, the first terminal requests a user authentication to the server (S410).

Then, the server searches a database according to the authentication request from the first terminal to confirm whether the first shopping cart is a shopping cart which is owned by the corresponding shopping mall. When confirmed that the shopping cart is owned by the corresponding shopping mall as a result of the confirmation, it is confirmed whether the second terminal installed on the second shopping cart is connected to the server (S420). As a result of the confirmation, when the second terminal installed on the second shopping cart is connected to the server, the server requests an image registration to the first terminal (S430).

Subsequently, according to the image registration request from the server, the first terminal uploads the first product image information (S440), and when the upload of the first product image information has been completed, the server transmits the first product image information that the upload has been completed to the second terminal installed on the second shopping cart (S450).

Next, the second user selects service items transmitting the product image through the second terminal installed in the second shopping cart (S460), and accordingly, the first product image information transmitted from the first shopping cart can be confirmed.

As described above, in the present invention, shopping carts inter-exchange product list information, text information and product image information, or the like through terminals installed on the shopping carts. Therefore, users visiting a shopping mall together can conveniently enjoy shopping using a mobile network system.

According to exemplary embodiments of the present invention, shopping participants form a group and exchange a variety of product information through communication realized within the group, such that the shopping participants may easily obtain the variety of product information and efficient shopping is possible due to reduction in the shopping time.

In a large shopping mall such as a large discount store, department store and the like, high costs are not required by applying a communication way realized within a group, and many customers can be secured by providing a wide range of services.

A number of exemplary embodiments have been described above. Nevertheless, it will be understood that various modifications may be made. For example, although an example in the form of broadcasting service when the image transmission service between the shopping carts is provided from any one shopping cart of shopping carts forming a group to other shopping cart is described in the above-described embodiment, the present invention, of course, may include a group image calling service between the shopping carts. Accordingly, other implementations are within the scope of the following claims.

What is claimed is:

1. A terminal system comprising:
a first terminal, which is installed on a first indoor transport unit of shopping products, to be connected to a server through a first wireless LAN device installed on a first display stand and generates first product information of products arranged on the first display stand in connection with the server; and
a second terminal, which is installed on a second indoor transport unit of the shopping products, to be connected to the server though a second wireless LAN device installed on a second display stand and generates a second product information of products arranged on the second display stand in connection with the server,
wherein the first and the second terminals inter-exchange the first product information and the second product information through the first wireless LAN device, the second wireless LAN device and the server.

2. The system of claim 1, wherein the first terminal generates the first product information including first product list information of products arranged on the first display stand generated through a search service provided from the server in connection with the server and first product image information captured from products arranged on the first display stand, and
the second terminal generates the second product information including second product list information of products arranged on the second display stand generated through the search service provided from the server in connection with the server and second product image information captured from products arranged on the second display stand.

3. The system of claim 2, wherein the first terminal includes:
a camera unit which generates the first product image information captured from the products arranged on the first display stand;
a data processing unit which encodes the first product image information;
a wireless communication unit that transmits the encoded first product image information to the second terminal through the first wireless LAN device, the server and the second wireless LAN device according to a wireless communication way; and
a display unit that displays the second product information received from the second terminal through the first wireless LAN device, the second wireless LAN device and the server; and
the second terminal includes:
a camera unit which generates the second product image information captured from the products arranged on the second display stand;
a data processing unit which encodes the second product image information;
a wireless communication unit which transmits the encoded second product image information to the first wireless LAN device according to a wireless communication way; and
a display unit which displays the second product information received from the second terminal through the first wireless LAN device, the second wireless LAN device and the server.

4. The system of claim 1, wherein the first terminal receives location information of the second terminal determined by the server based on identification information of the second wireless LAN device as location information of the second indoor transport unit through the first wireless LAN device, and
the second terminal receives location information of the first terminal determined by the server based on identification information of the first wireless LAN device as location information of the first indoor transport unit through the second wireless LAN device.

5. The system of claim 4, wherein the first and second terminals receive distance information to a terminal of the other party from the server based on the location information of the first terminal and the location information of the second terminal, respectively.

6. A shopping system comprising:
first and second wireless LAN devices each installed on a first and a second display stands in a shopping mall;
a first terminal installed on a first indoor transport unit transporting products to communicate with the first wireless LAN device in wireless and having an image capturing unit;
a server receiving product image information captured from products arranged on the first display stand by using the image capturing unit of the first terminal through an Internet network in connection with the first wireless LAN device and the second wireless LAN device; and
a second terminal installed on a second indoor transport unit transporting products to communicate with the second wireless LAN device in wireless and having an image display unit to display the product image information captured from products arranged on the first display stand received from the server through the Internet network and the second wireless LAN device on the image display unit.

7. The system of claim 6, wherein the second terminal further receives from the first terminal product list information and text information of the products that a user of the first indoor transport unit recommends to a user of the second indoor transport unit, in addition to the product image information from the first terminal.

8. A shopping method comprising:
connecting a first terminal installed on a first indoor transport unit transporting products to a server connected to an Internet network through a first wireless LAN device installed on a first display stand in a shipping mall;
connecting a second terminal installed on a second indoor transport unit to the server connected the internet network through a second wireless LAN device installed on a second display stand;
configuring a session between the first terminal and the second terminal for group communication between the first indoor transport unit and the second indoor transport unit by the server; and
inter-exchanging product information between the first terminal and the second terminal according to the configured session.

9. The method of claim 8, wherein the product information includes text information, product list information and product image information captured from the products through cameras included in the first and second terminals.

10. The method of claim 8, wherein the inter-exchanging of the product information between the first terminal and the second terminal according to the configured session includes:
displaying shopping service items having product list transmission service items, text transmission service items and product image transmission service items through the first terminal and the second terminal; and
generating the product information corresponding to service items selected by a user among the shopping service items and inter-exchanging the respective generated product information based on the configured session, through the first and second terminals.

11. The method of claim 10, wherein the inter-exchanging of the product information according to the product image transmission service selected by the user includes:
capturing products arranged on a first display stand through an image capturing device included inside by the first terminal;
transmitting product images captured by the first terminal to the server through the first wireless LAN device and the Internet network; and
transmitting the product images received by the server to the second terminal through the internet network and the second wireless LAN device.

12. The method of claim 8, wherein the configuring of the session between the first terminal and the second terminal by the server configures a session between the first terminal and the second terminal by receiving identification information of the first and second terminals by the server and identification information of the first and second wireless LAN devices.

13. The method of claim 12, wherein the server identifies location information of the first and second indoor transport units based on identification information of the first and second wireless LAN devices and generates movement distance information between the first and second indoor transport units according to the identified results.

14. The method of claim 13, wherein the first and second terminals receives the movement distance information generated by the server, respectively, the first terminal determines a location of the second indoor transport unit on which the second terminal is installed, according to the received movement distance information, and the second terminal determines a location of the first indoor transport unit on which the first terminal is installed, according to the received movement distance information.
